(19) United States
(12) Patent Application Publication
(10) Pub. No.: US 2022/0205061 A1
(43) Pub. Date: Jun. 30, 2022

(54) MATERIALS AND PROCESSES FOR RECOVERING PRECIOUS METALS

(71) Applicant: CLEAN EARTH TECHNOLOGY PTY LTD, East Perth, Western Australia (AU)

(72) Inventors: Justin Mark CHALKER, Forrestville (AU); Maximilian MANN, Kensington Gardens (AU)

(73) Assignee: CLEAN EARTH TECHNOLOGY PTY LTD, East Perth, Western Australia (AU)

(21) Appl. No.: 17/601,313

(22) PCT Filed: Mar. 31, 2020
(86) PCT No.: PCT/AU2020/000025

§ 371 Date: Oct. 4, 2021

(30) Foreign Application Priority Data
Apr. 3, 2019 (AU) 2019901135

(51) Int. Cl. C22B 11/00; C22B 3/24; C22B 7/00; C22B 3/06

(52) U.S. Cl. CPC C22B 11/042; C22B 3/06; C22B 7/007; C22B 3/24

(57) ABSTRACT

A process for recovering a precious metal from a precious metal containing article or composition is disclosed. The process comprises treating the precious metal containing article or composition with an oxidant composition under conditions to oxidise the precious metal in the precious metal containing article or composition to obtain a precious metal salt composition. The precious metal salt composition is then contacted with a sorbent under conditions to adsorb at least some of the precious metal salt to the sorbent to obtain a laden sorbent. At least some of the precious metal is then recovered from the laden sorbent. Alternatively, the precious metal is recovered from the precious metal salt composition by chemical reduction, electrochemical reduction and/or chemical precipitation.

The present application claims priority from Australian Provisional Patent Application No. 2019901135 titled “MATERIALS AND PROCESSES FOR RECOVERING PRECIOUS METALS” and filed on 3 Apr. 2019, the content of which is hereby incorporated by reference in its entirety.

### FIELD

The present disclosure relates to compositions and processes for recovering precious metals such as gold and silver from crude ores, tailings, waste streams, electronic waste, and the like.

### BACKGROUND

Gold extraction and recovery is an economically important activity in mining and e-waste recovery worldwide (1, 2). In both activities, there is increasing pressure to adopt sustainable gold extraction techniques that minimise harm to miners and the environment (3). Accordingly, there is a growing demand to identify alternatives to mercury and cyanide, two widely used toxic reagents that are efficient at extracting gold (4). Notable contributions to this area include the use of thiosulfate (5) and halogen based leaching processes (6, 7). As promising as these results may be, they have had limited uptake on a large scale in either formal or informal mining or in electronic waste. Moreover, these techniques often require careful control of the extractive conditions including pH and co-oxidant (5) or they require expensive reagents (6) or corrosive solvents (7).

Accordingly, there is a need for processes for recovering gold or other precious metals from mining, e-waste, etc that address one or more of the problems associated with existing processes and/or provide an alternative to existing processes.

### SUMMARY

In a first aspect of the present disclosure, there is provided a process for recovering a precious metal from a precious metal containing article or composition, the process comprising:
treating the precious metal containing article or composition with an oxidant composition under conditions to oxidise the precious metal in the precious metal containing article or composition to obtain a precious metal salt composition;
contacting the precious metal salt composition with a sorbent under conditions to adsorb at least some of the precious metal salt to the sorbent to obtain a laden sorbent; and
recovering at least some of the precious metal from the laden sorbent.

In certain embodiments of the first aspect, the sorbent is capable of selectively adsorbing at least some of the precious metal salt to the sorbent to obtain a laden sorbent.

In a second aspect of the present disclosure, there is provided a process for recovering a precious metal from a precious metal containing article or composition, the process comprising:
treating the precious metal containing article or composition with an oxidant composition comprising at least one halide ion source and at least one electrophilic halogen source under conditions to oxidise the precious metal in the precious metal containing article or composition to obtain a precious metal salt composition; and
recovering at least some of the precious metal from the precious metal salt composition.

In certain embodiments of the first and second aspects, the precious metal is recovered from the laden sorbent or the precious metal salt composition by chemical reduction, electrochemical reduction and/or chemical precipitation.

In a third aspect of the present disclosure, there is provided a sorbent having a precious metal salt adsorbed thereto formed by the process of the first aspect.

In a fourth aspect of the present disclosure, there is provided a precious metal recovered from a precious metal containing article or composition using the process of the first aspect.

### BRIEF DESCRIPTION OF FIGURES

Embodiments of the present disclosure will be discussed with reference to the accompanying figures wherein:

FIG. 1 shows a UV-Vis spectrum obtained from the reaction between TCCA and NaBr in water;

FIG. 2 shows a plot of time vs gold (III) concentration obtained from Example 4;

FIG. 3 shows an SEM micrograph showing gold metal nanoclusters formed on the polysulfide polymer in Example 4;

FIG. 4 shows the results of Energy dispersive X-ray (EDX) analysis of gold metal nanoclusters formed on the polysulfide polymer in Example 4;

FIG. 5 shows a photograph of gold metal recovered from Example 5.2;

FIG. 6 shows the results of Energy dispersive X-ray (EDX) analysis of gold metal recovered from Example 5.2;

FIG. 7 shows the results of Energy dispersive X-ray (EDX) analysis of gold metal recovered from Example 7;

FIG. 8 shows the results of Energy dispersive X-ray (EDX) analysis of gold metal recovered from Example 8;

FIG. 9 shows a retort apparatus for scrubbing sulfur dioxide generated during polymer incineration;

FIG. 10 shows an ion chromatograph that shows a sulfate was detected in the scrubbing solution, indicating the sulfur dioxide gas generated during polymer incineration can be easily trapped using the same oxidants employed in the gold oxidation;

FIG. 11 shows an SEM micrograph of gold particles formed by treating a leach solution with ascorbic acid (Example 14);

FIG. 12 shows X-ray data (EDX) of gold particles formed by treating a leach solution with ascorbic acid (Example 14) and indicates the particles are high purity gold;

FIG. 13 shows an SEM micrograph of gold particles formed by treating a leach solution with hydrogen gas (Example 15);

FIG. 14 shows X-ray data (EDX) of gold particles formed by treating a leach solution with hydrogen gas (Example 15) and indicates the particles are high purity gold;

FIG. 15 shows an SEM micrograph of gold leached and recovered from ore concentrates using a polymer sorbent followed by incineration (Example 16);

FIG. 16 shows X-ray data (EDX) of gold leached and recovered from ore concentrates using a polymer sorbent followed by incineration (Example 16) and indicates the material is gold;

FIG. 17 shows an SEM micrograph of gold recovered using polysulfide polymer followed by incineration (Example 17);

FIG. 18 shows X-ray data (EDX) of gold recovered using polysulfide polymer followed by incineration (Example 17);

FIG. 19 shows an SEM micrograph of gold recovered using ascorbic acid reductive precipitation (Example 17); and

FIG. 20 shows X-ray data (EDX) of gold recovered using ascorbic acid reductive precipitation (Example 17).

### DETAILED DESCRIPTION

Unless otherwise defined, all terms used in the present disclosure, including technical and scientific terms, have the meaning as commonly understood by one of ordinary skill in the art. By means of further guidance, term definitions are included to better appreciate the teaching of the present disclosure.

As used herein, the following terms have the following meanings:

“A”, “an”, and “the” as used herein refers to both singular and plural referents unless the context clearly dictates otherwise. By way of example, “an oxidant” refers to one or more than one oxidant.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

The expression “% by weight” (weight percent), here and throughout the description unless otherwise defined, refers to the relative weight of the respective component based on the overall weight of the formulation or element referred to.

The recitation of numerical ranges by endpoints includes all numbers and fractions subsumed within that range, as well as the recited endpoints, except where otherwise explicitly stated by disclaimer and the like.

The present inventors have surprisingly found that certain sorbents, such as polymeric polysulfides, can be used to selectively recover precious metals, such as gold and silver, from a range of compositions and articles that contain the precious metal. The precious metals can be recovered by oxidising the metal to form a precious metal salt and then selectively adsorbing the precious metal salts to the sorbent. Surprisingly, the precious metal can be recovered from the sorbent in a straightforward and environmentally benign manner. In addition, the present inventors have surprisingly found that certain poly sulfide polymer sorbents not only selectively adsorb certain precious metal salts from solution but they also reduce the precious metal salts to form the precious metal in situ.

Accordingly, in a first aspect, there is provided a process for recovering a precious metal from a precious metal containing article or composition. The process comprises treating the precious metal containing article or composition with an oxidant composition under conditions to oxidise the precious metal in the precious metal containing article or composition to obtain a precious metal salt composition. The precious metal salt composition is then contacted with a sorbent under conditions to adsorb at least some of the precious metal salt to the sorbent to obtain a laden sorbent. At least some of the precious metal is then recovered from the laden sorbent.

In a second aspect, there is provided a process for recovering a precious metal from a precious metal containing article or composition. The process comprises treating the precious metal containing article or composition with an oxidant composition comprising at least one halide ion source and at least one electrophilic halogen source under conditions to oxidise the precious metal in the precious metal containing article or composition to obtain a precious metal salt composition; and recovering at least some of the precious metal from the precious metal salt composition.

The precious metal can be any naturally occurring metallic chemical element of high economic value. Precious metals include gold, silver, ruthenium, rhodium, palladium, osmium, iridium, and platinum. In certain specific embodiments of the present disclosure, the precious metal is gold. In certain other specific embodiments of the present disclosure, the precious metal is silver.

Advantageously, the present inventors have found that certain polysulfide polymers (described in detail later) are able to adsorb gold ions from solution with selectivity over other metal ions that may commonly be found in gold containing ores and tailings, such as Al³⁺, Cu²⁺, Zn²⁺, Fe³⁺, As⁵⁺, Cd²⁺ and/or Pb²⁺.

The precious metal containing article or composition can be any solid, liquid or gas containing the precious metal. The process of the present disclosure is particularly suitable for the recovery, extraction, separation and/or purification of precious metals present in ores, mining tailings, electronic waste and other secondary sources of precious metals. As used herein, the term “recovery” is intended to mean extraction, separation and/or purification.

The oxidant composition comprises at least one halide ion source and at least one electrophilic halogen source. The present disclosure is predicated, at least in part, by the inventors' finding that a range of readily available and relatively environmentally benign oxidants, such as trichloroisocyanuric acid (TCCA), can be combined with a range of readily available and relatively environmentally benign halogen salts, such as sodium bromide, to form an oxidant that can react with gold metal and extract the gold into water. To the best of the inventors' knowledge, this is the first example of using sodium bromide and TCCA together in a reaction with gold. The inventors also found that a range of halide ion sources and electrophilic halogen sources can be used to oxidise the precious metal to form the water soluble precious metal salt.

As used herein, the term “oxidise the precious metal in the precious metal containing article or composition” is to be understood to mean that at least some of the precious metal in the precious metal containing article or composition is oxidised but it may be that the oxidation reaction does not result in complete oxidation of all of the precious metal.

In certain embodiments, the halide ion source comprises chloride ions. The halide ion source in these embodiments could be any one or more of sodium chloride, potassium chloride, and hydrogen chloride.

In certain other embodiments, the halide ion source comprises bromide ions. The halide ion source in these embodiments could be any one or more of sodium bromide, potassium bromide, and hydrogen bromide.

In still other embodiments, the halide ion source comprises iodide ions. The halide ion source in these embodiments could be any one or more of sodium iodide, potassium iodide, and hydrogen iodide.

The halide ion source could also be a combination of any of the aforementioned halide ion sources.

The electrophilic halogen source may be selected from one or more of the group consisting of hypobromous acid, hypochlorous acid, hyprobromite salts, hypochlorite salts, bromochlorodimethylhydantoin (BCDMH), sodium dichloroisocyanurate (SDIC), dichloroisocyanuric acid, trichloroisocyanuric acid (TCCA), sodium dibromoisocyanurate, dibromoisocyanuric acid, and tribromoisocyanuric acid.

In certain specific embodiments, the halide ion source is sodium bromide and the electrophilic halogen source is trichloroisocyanuric acid. Sodium bromide and trichloroisocyanuric acid react with gold metal in a one-pot reaction to generate a water-soluble gold bromide salt and cyanuric acid. Cyanuric acid is non-toxic and biodegradable, so the tailings and/or waste in this process are less toxic than tailings that contain mercury or cyanide as commonly found in gold processing operations. Furthermore, trichloroisocyanuric acid is commonly used as a sanitation reagent for swimming pools, so it is widely available and considered less toxic than competing gold lixiviants such as mercury and cyanide.

Under the oxidation conditions used, the precious metal in the precious metal containing article or composition is oxidised to a precious metal salt composition. The oxidation reaction can be carried out at a temperature of from about 10° C. to about 100° C., such as 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C. or 100° C. In certain embodiments, the oxidation reaction is carried out at a temperature of from about 20° C. to about 60° C., such as about 50° C. to about 60° C.

The oxidation conditions may utilise methods to increase the rate of the oxidation reaction, such as sonication or sonication with heating. The sonication can be applied to the oxidation reaction using any suitable type of transducer, such as a conventional ultrasonic horn known in the art. Variables which can be adjusted in the application of sonication include, but are not limited to, the frequency of sonication applied, the power intensity at which the sonication is applied, the length of time the sonication is applied, the location of the transducer within the oxidation reaction vessel, and so forth. In most embodiments the applied energy will be ultrasonic energy, i.e., 17 kilohertz (kHz) or greater.

The oxidation reaction can be carried out at a pH of from about pH 1.0 to about pH 12.0, such as 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, or 12.0. In certain embodiments, the oxidation reaction is carried out at a pH of from about pH 4.0 to about pH 8.0.

The oxidised and water-soluble precious metal can be recovered by various methods including, but not limited to, electrochemical reduction, chemical reduction, chemical precipitation, sorption onto activated carbon, and sorption onto polymer sorbents.

In certain embodiments, the oxidised and water-soluble precious metal is recovered by sorption onto a suitable sorbent. In certain of these embodiments, the sorbent is a polysulfide polymer. The poly sulfide polymer may be formed using any of the methods disclosed in published International Patent Application No. WO 2017/181217, the details of which are hereby incorporated by reference. Briefly, in these methods a poly sulfide polymer is formed by reacting a fatty acid composition comprising at least one unsaturated fatty acid or derivative thereof with sulfur, at a weight ratio between 9:1 and 1:9, under inverse vulcanisation conditions to produce a polymeric polysulfide wherein at least 50% of the fatty acids or derivatives thereof in the fatty acid composition are unsaturated.

The fatty acid composition may be a glyceride composition. The glyceride composition may comprise either one or both of a triglyceride and a diglyceride in a substantially pure form. In certain embodiments, the glyceride composition comprises a mixture of either one or both of triglycerides and diglycerides. In certain embodiments either one or both of the triglyceride and the diglyceride comprise at least one fatty acid having 8 to 24 carbon atoms in the chain inclusive, including, but not limited to, α-linolenic acid, stearidonic acid, stearic acid, ricinoleic acid, dihydroxystearic acid, eicosapentaenoic acid, docosahexaenoic acid, linoleic acid, γ-linolenic acid, dihomo-γ-linolenic acid, arachidonic acid, docosatetraenoic acid, palmitoleic acid, vaccenic acid, paullinic acid, oleic acid, elaidic acid, gondoic acid, erucic acid, nervonic acid or mead acid.

In certain embodiments, the glyceride composition comprises at least one naturally derived oil or synthetic oil. In certain embodiments, the glyceride composition comprises or is derived from at least one oil of acai palm, avocado, brazil nut, canola, castor, corn, cottonseed, grape seed, hazelnut, linseed, mustard, peanut, olive, rice bran, safflower, soybean or sunflower.

Advantageously, the glyceride composition may be a used natural or synthetic oil composition, such as an oil that has previously been used for the production of foodstuffs. This then provides a relatively cheap and/or environmentally useful glyceride composition.

In certain other embodiments, the fatty acid composition is a fatty acid ester composition. The fatty acid ester composition may comprise esters of any one or more unsaturated fatty acids. The ester may be an alkyl ester, such as a methyl ester, an ethyl ester or a propyl ester. The fatty acid esters may be formed from by esterification of fatty acids or by transesterification of a glyceride composition or a fatty acid derivative, such as a fatty acid amide. In certain embodiments the fatty acid has 8 to 24 carbon atoms in the chain inclusive. The fatty acid may be selected from one or more of the group, including, but not limited to, α-linolenic acid, stearidonic acid, stearic acid, ricinoleic acid, dihydroxystearic acid, eicosapentaenoic acid, docosahexaenoic acid, linoleic acid, γ-linolenic acid, dihomo-γ-linolenic acid, arachidonic acid, docosatetraenoic acid, palmitoleic acid, vaccenic acid, paullinic acid, oleic acid, elaidic acid, gondoic acid, erucic acid, nervonic acid or mead acid.

The fatty acid ester may be derived from a natural oil or a synthetic oil. In certain embodiments, the fatty acid ester is derived from at least one oil of acai palm, avocado, brazil nut, canola, castor, corn, cottonseed, grape seed, hazelnut, linseed, mustard, peanut, olive, rice bran, safflower, soybean or sunflower.

In certain embodiments, the weight ratio of the fatty acid composition and the sulfur is between 9:1 and 1:9. For example, 8:1, 7:1, 6:1, 5:1, 5:2, 2:1, 3:2, 1:1, 2:3, 1:2, 2:5, 1:5, 1:6, 1:7 or 1:8. Accordingly, in certain embodiments where the fatty acid composition is an oil, such as canola oil, the ratio of canola oil to sulfur could be 1:1. In certain embodiments, the weight ratio of the glyceride composition and the sulphur may be modified as appropriate.

In certain embodiments, the sulfur comprises elemental sulfur. In certain embodiments, the sulphur comprises at least one allotrope of sulphur such as S5, S6, S7 or S8. In certain embodiments, S8 is at least one of alpha-sulfur (commonly called sulfur flowers), beta-sulfur (or crystalline sulfur) or gamma-sulfur (also called mother of pearl sulfur). In certain embodiments, the sulfur comprises any poly-S reagent, intermediate, or product generated from sulphide (such as sodium sulphide), sodium chloride or hydrogen sulphide.

The polysulfide polymer may be a solid. In certain embodiments, the polysulfide polymer is a rubber. In certain embodiments, the polysulfide polymer is elastic and malleable at temperatures up to approximately 150° C., whereupon the polysulfide polymer starts to decompose. In certain embodiments, the polysulfide polymer starts to decompose at temperatures above approximately 150, 155, 160, 165, 170, 175, 180, 185, 190, 195, 200, 205, 210, 215, 220, 225, 230, 235, 240, 245 or 250° C. The temperature at which the polysulfide polymer starts to decompose may be increased by, for example, increasing the sulfur content.

In alternative embodiments, the polysulfide polymer is a liquid. Liquid polysulfide polymers can be formed by reacting fatty acid esters with sulfur at weight ratios between 9:1 and 1:9.

The polysulfide polymer is formed by reacting the fatty acid composition with sulfur under inverse vulcanisation conditions. Inverse vulcanisation involves adding the fatty acid composition to relatively high weight percentages of liquid sulfur. This is in contrast to classic vulcanisation which involves adding relatively low weight percentages of sulfur to a hot fatty acid composition.

The precious metal salt composition is contacted with the sorbent under conditions for the latter to adsorb at least some of the precious metal salt to the sorbent to obtain a laden sorbent.

Optionally, the precious metal salt composition may undergo a pre-treatment process prior to contact with the sorbent. For example, the pH of the precious metal salt composition may be adjusted prior to contact with the sorbent. In certain embodiments, the precious metal salt composition is filtered to remove any solids before it is contacted with the sorbent. This step may be important for ore and tailings that have a lot of insoluble debris as the solids can block the reactive surface of sorbents in the precious metal recovery steps.

The precious metal salt composition may be contacted with more than one sorbent. When more than one sorbent contacts the precious metal salt composition, each sorbent may contact the precious metal salt composition sequentially or non-sequentially.

The sorbent may be brought into contact with the precious metal salt composition in any suitable manner. In certain embodiments, the sorbent is brought into contact with the precious metal salt composition in a vessel such as a beaker, tube, pipe, bottle, flask, carboy, bucket, tub, tank, in any other suitable vessel known in the art or in any other means of storing, containing or transferring the precious metal salt composition. In certain embodiments the sorbent contacts the precious metal salt composition in a batch or continuous process.

Optionally, the sorbent may be agitated when contacting the precious metal salt composition. Any suitable method of agitation may be used including shaking, staring, vortex mixing, magnetic stirring and sparging.

The time required to contact the precious metal salt composition with the sorbent depends on many factors including: the composition of the sorbent, the temperature, agitation and any other relevant factors. In certain embodiments, the precious metal salt composition is contacted with the sorbent for a time period between 1 minute and 24 hours.

Advantageously, the oxidation and extraction and subsequent recovery of precious metal can be carried out in one pot. For example, sodium bromide and tricholoroisocyanuric acid can be added to a source of gold, followed by selective sorption onto a polymer surface. In the case of a polysulfide polymer, the polymer can be added directly to the gold solution or added in a bunded form.

At least some of the precious metal is then recovered from the laden sorbent. The process of recovering the precious metal from the laden sorbent comprises separating the laden sorbent from the precious metal salt composition. The precious metal can be recovered from the laden sorbent by converting the precious metal salt to elemental precious metal by chemical reduction, electrochemical reduction, chemical precipitation, sorption onto activated carbon, and sorption onto polymer sorbents. Thus, the process comprises reducing at least some of the precious metal salt adsorbed on the sorbent to form the precious metal. Advantageously, the present inventors have found that, at least in the case of gold, the precious metal salt is reduced in situ by the polysulfide polymer described above to form gold metal on the polymer sorbent. In other cases, the precious metal salt adsorbed on the sorbent can be reduced by reacting it with a suitable reducing agent known in the art such as zinc metal, sodium borohydride, hydrogen gas, ascorbic acid, electrochemical deposition and other common reducing agents. Alternatively, the precious metal salt adsorbed on the sorbent can be reduced by electrochemical reduction.

In certain embodiments, the oxidant is used to oxidise the precious metal and convert it into a water-soluble precious metal salt. This solution is then filtered and separated from any remaining solid. Next, a reducing agent such as ascorbic acid or hydrogen gas is added to the precious metal salt composition. The precious metal is reduced and precipitates as elemental precious metal. If there is copper in the solution, a copper binding ligand such as EDTA or water soluble amino acids and diamines that bind to copper, can be added to bind to copper. The precious metal can then be selectively reduced and precipitated by the addition of ascorbic acid or hydrogen gas. The ascorbic acid or hydrogen also quench any excess oxidant during this step. The amount of the ascorbic acid or hydrogen gas required will depend on the amount of oxidant used in the first step. At a minimum, there must be an equimolar ratio of the reducing agent and oxidant plus an additional molar equivalent to the precious metal.

Advantageously, the processes described herein can be used to selectively separate gold from tailings or similar compositions containing other metals. For example, tailings containing gold and other metals, including mercury, can be contacted with the oxidant composition under conditions to oxidise the majority of the gold present in the tailings. Under the conditions described herein gold (>99%), mercury (>99%), and nickel (>99%) leach into solution faster than some other metals such as copper and iron. A sorbent can then be used to recover the gold. The polysulfide polymer described herein was shown to more rapidly remove gold than any other component of the leach solution. Additionally, this demonstrates that the oxidant composition can also be used to wash mercury from tailings. The mercury can be removed from the leach solution by addition of more polysulfide polymer or by the addition of activated carbon. The use of the oxidant solution to remediate mercury also extends to soil, sludge and other mixed waste and solid waste. The oxidant solution oxidises the mercury and makes it soluble, and the polymer or activated carbon or another comparable sorbent can remove the mercury from water.

The use of the leach solution to remediate mercury extends to soil, sludge and other mixed waste and solid waste. This should be claimed explicitly. The leach solution oxidised the mercury and makes it soluble, and the polymer or activated carbon or another comparable sorbent can remove the mercury from water.

The precious metal is separated from the sorbent. The process of separating the precious metal from the sorbent may comprise degrading the sorbent. The sorbent can be degraded by chemical, thermal, and/or physical means. For example, when the sorbent is the polysulfide polymer referred to above, the polysulfide polymer can be degraded by dissolution in pyridine. Alternatively, when the sorbent is the polysulfide polymer referred to above, the polysulfide polymer can be degraded by incineration. For example, when gold is bound to the polysulfide polymer, the gold can be recovered by incineration of the polymer. This process generates off gasses such as sulfur dioxide that are preferably trapped, scrubbed or destroyed. This can be done in a furnace equipped with a scrubber packed with lime sorbent or other commonly used methods of flue-gas desulfurisation. The polymer incineration can also be done using a small-scale retort in which the off-gases from the incinerated polymer are bubbled through a solution of water and trichloroisocyanuric acid. In this way, the same components of the leach solution can be used to convert sulfur dioxide to sulfate.

In a third aspect, there is provided a sorbent having a precious metal salt adsorbed thereto formed by the process of the first aspect.

In a fourth aspect, there is provided a precious metal recovered from a precious metal containing article or composition using the process of the first aspect.

As would be appreciated by the person skilled in the art, the above aspects of the present disclosure need not be limited to the description of each individual aspect, but may import features from other aspects, for example, importing features of the method of the third aspect into the use of the fourth aspect.

### EXAMPLES

### Example 1—Solid Polysulfide Polymer Synthesis

Sulfur (technical grade, 20.0 g) was added to a 100 mL round bottom flask and then melted with stirring to 180° C. Canola oil (20.0 g) was then added dropwise over 3-5 minutes, resulting in a two-phase mixture. The mixture was stirred vigorously to ensure efficient mixing of the two phases. The mixture appeared to form one phase after approximately 10 minutes. Heating was continued for an additional 10 minutes at 180° C. Over this time, the product formed a rubbery solid. The material was then removed from the flask and then blended for 3 minutes (8.5 cm rotating blade) to provide rubber particles ranging in size from 0.2 to 12 mm in diameter with an average diameter of 2 mm. The particles were then transferred to a 250 mL round bottom flask and treated with enough 0.1 M NaOH to cover the particles entirely (˜60 mL). This mixture was stirred for 90 minutes at room temperature to remove residual hydrogen sulfide. After this time, the particles were isolated by filtration and then washed on the filter with deionised water (3×˜50 mL). The particles were then collected from the filter and air dried at room temperature and pressure for 24 hours. Typically, this procedure provided a final mass of between 38-40 g of the washed and dried polymeric polysulfide particles (95-99% yield).

### Example 2—Gold Oxidation and Dissolution

A solution of oxidant (100 mg) was prepared in water (15 mL). An additional reagent (HCl and/or NaBr) was added so that each solution had the same molar concentration of total halides. Gold wire (1 mg) was added to the solutions and all were incubated for 8 hours at 25° C. before recovering and weighing the undissolved gold. All solutions were effective at dissolving gold. Hypochlorous acid and chlorine solutions below pH 3.0 dissolved gold most rapidly (Trials 3, 4, 5, and 8). Trial 7, while slower, was the most effective at higher pH and did not require the addition of corrosive acids. Moreover, TCCA is non-toxic and biodegradable and the reagents (TCCA and NaBr) can be transported easily as solids.

The following oxidants were used:

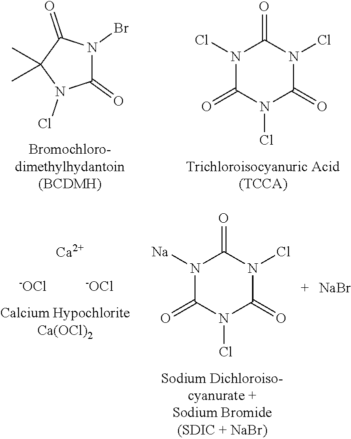

The results are shown in the following table.

| | | | | Gold | Gold |
|---|---|---|---|---|---|
| | | | | dissolution | dissolution |
| | Electrophilic | | | (wt % of Au | (wt % of Au |
| | halogen | Halide ion | | oxidised | oxidised |
| | source (i.e. | source (i.e. | | and dissolved) | and dissolved) |
| Trial | oxidant) | additive) | pH | Test 1 | Test 2 |
| 1 | ⁻OCl | HCl | 7.13 | 59 | 51 |
| | | NaBr | | | |
| 2 | Ca(OCl)₂ | HCl | 6.50 | 44 | 42 |
| | | NaBr | | | |
| 3 | ⁻OCl | HCl | 0.69 | 74 | 37 |
| 4 | Ca(OCl)₂ | HCl | 1.45 | 71 | 100 |
| 5 | TCCA | NaCl | 2.5 | 75 | 84 |
| 6 | SDIC + | NaBr | 7.11 | 48 | 49 |
| | NaBr | | | | |
| 7 | TCCA | NaBr | 6.54 | 31 | 69 |
| 8 | TCCA | HCl | 0.61 | 100 | 91 |

### Example 3—In-Situ Generation of Hypobromous Acid Using Trichloroisocyanuric Acid and Sodium Bromide

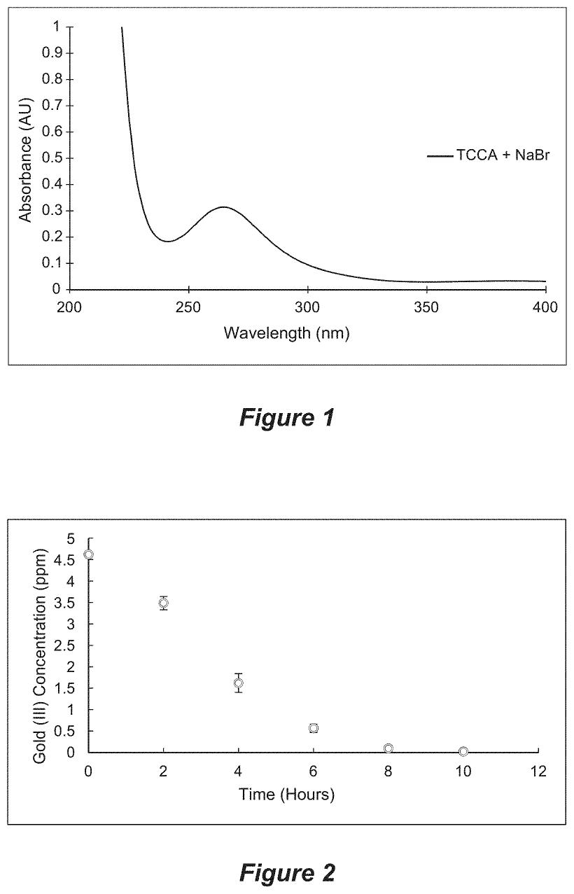

TCCA and NaBr were dissolved in a 1:3 molar ratio in water and the resulting UV-Vis spectrum was recorded (FIG. 1). The reaction between TCCA and NaBr produces a species with an absorption maximum at 264 nm, which is consistent with the in situ formation of hypobromous acid (HOBr).

### Example 4—Recovery of Gold

A sulfur polymer was prepared by the inverse vulcanisation of sulfur and canola oil according to Example 1 and/or previously published procedures [Chem. Eur. J. 2017, 23, 16219-16230 and WO 2017181217]. This polymer was used as a sorbent for dissolved ionic gold. Accordingly, a cotton tea bag (2×9 cm) containing 1 g of polysulfide polymer was added to a 5 ppm Au³⁺ (from AuCl₃) solution in a centrifuge tube. The tube was rotated at 25 RPM and an aliquot (1.9 mL) of the Au³⁺ solution was removed for analysis at 2, 4, 6, 8 and 10 hours. After 10 hours >99.9% of the gold was removed from solution and bound to the polymer (FIG. 2).

Scanning Electron Microscopy (SEM) of Polymer-Bound Gold

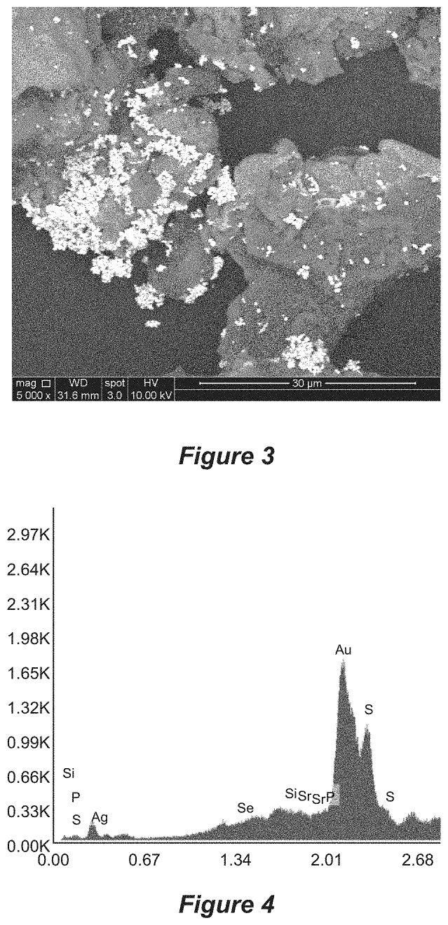

The polysulfide polymer used to remove the gold from solution is redox active and reduces the ionic gold to gold metal. The SEM micrograph (FIG. 3) shows gold metal nanoclusters on the polymer. Gold composition was confirmed by energy-dispersive X-ray spectroscopy (FIG. 4).

### Example 5—Gold Recovery from Polymer

Example 5.1: 1.0 g of polysulfide polymer was exposed to 50 mL of 500 ppm AuCl₃ for 9 hours. The polymer and bound gold were then recovered by filtration. After drying, the polymer was dissolved in pyridine (5 mL) with assistance by sonication (10 minutes). The solid gold metal could be recovered by filtration and its identity was confirmed by energy-dispersive X-ray spectroscopy.

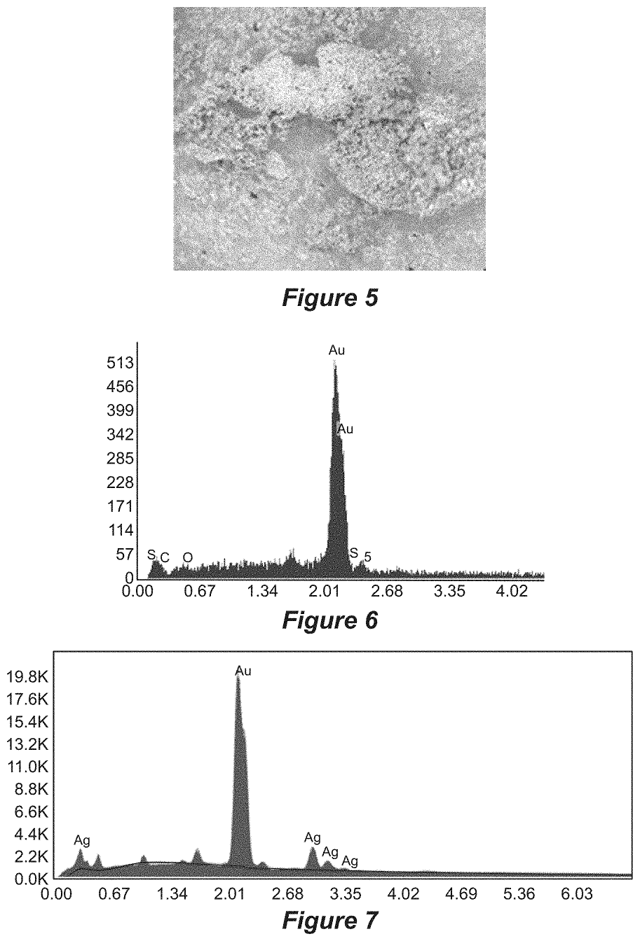

Example 5.2: The polysulfide polymer-bound gold (1 g polymer bound to 42 mg gold) was recovered and placed in a crucible. The polymer was then incinerated using either a Fisher burner or a furnace (>600° C.). The gold metal was recovered from the crucible in >95% yield. The recovered gold is shown in FIG. 5, with identity confirmed by energy-dispersive X-ray spectroscopy (FIG. 6).

### Example 6—Selective Uptake of Gold in a Mixture of Metal Salts

Example 6.1: A 50 mL solution was prepared in a plastic tube so that the final concentration was 5 ppm each of AuCl₃, AlCl₃, CuBr₂, ZnSO₄, FeCl₃. To this mixture of ions was added polysulfide polymer (1 g), bunded in a cotton teabag. The concentration of metal ions was measured at 7 hours and then again at 72 hours by ICP-MS. Metal uptake is shown in the tables below with each value indicating the concentration of metal remaining in the solution (average of triplicate experiments). These results indicate that the polymer selectively removes gold from water and uptake of A1³⁺, Cu²⁺, Zn²⁺, and Fe³⁺ is negligible under these conditions.

| | Au³⁺ | Au³⁺ | Al³⁺ | Al³⁺ | Cu²⁺ | Cu²⁺ | Zn²⁺ | Zn²⁺ | Fe³⁺ | Fe³⁺ |
|---|---|---|---|---|---|---|---|---|---|---|
| | (ppm) | (%) | (ppm) | (%) | (ppm) | (%) | (ppm) | (%) | (ppm) | (%) |
| Stock | 5.67 | 100 | 3.94 | 100 | 5.51 | 100 | 5.36 | 100 | 5.43 | 100 |
| After | ≤0.02 | ≤0.35 | 3.94 | 100 | 5.15 | 94 | 5.01 | 94 | 4.99 | 92 |
| 7 Hr. | | | | | | | | | | |
| After | ≤0.02 | ≤0.35 | 4.03 | 102 | 5.23 | 95 | 5.09 | 95 | 5.09 | 94 |
| 72 Hr. | | | | | | | | | | |

Example 6.2: A 50 mL solution was prepared in a plastic tube so that the final concentration was 5 ppm each of AuCl₃, As₂O₅, Cd(NO₃)₂, and Pb((NO₃)₂. To this mixture of ions was added polysulfide polymer (1 g), bunded in a cotton teabag. The concentration of metal ions was measured at 7 hours and then again at 72 hours by ICP-MS. Metal uptake is shown in the tables below with each value indicating the concentration of metal remaining in the solution (average of triplicate experiments). These results indicate that the polymer selectively removes gold from water and uptake of As⁵⁺, Cd²⁺, and Pb²⁺ is negligible under these conditions.

| | Au³⁺ | Au³⁺ | As⁵⁺ | As⁵⁺ | Cd²⁺ | Cd²⁺ | Pb²⁺ | Pb²⁺ |
|---|---|---|---|---|---|---|---|---|
| | (ppm) | (%) | (ppm) | (%) | (ppm) | (%) | (ppm) | (%) |
| Stock | 4.84 | 100 | 4.64 | 100 | 4.99 | 100 | 5.16 | 100 |
| After | ≤0.2 | ≤4 | 4.67 | 101 | 4.96 | 100 | 4.87 | 94 |
| 8 Hr. | | | | | | | | |
| After | ≤0.2 | ≤4 | 4.72 | 102 | 4.93 | 99 | 4.85 | 94 |
| 42 Hr. | | | | | | | | |

### Example 7—Full Cycle of Gold Extraction and Recovery

Gold metal (50 mg) was treated with a 20 mL solution of TCCA (0.1 M) and NaBr (0.3 M) and incubated in a plastic tube without agitation for 6 days at 25° C. The gold completely oxidised and dissolved over this period. Next, 30 mL of water was added followed by a 1 g sample of canola oil polysulfide polymer, bunded in a cotton teabag. The polymer and leach solution were agitated using an end-over-end mixture at 20 RPM for 4 days. After this time, the polymer was removed from the solution and the bag and then incinerated in a crucible using a Fisher burner. Pure gold (45 mg) was recovered in 90% yield, with identity confirmed by energy-dispersive X-ray spectroscopy (FIG. 7).

### Example 8—Gold Extraction from Ore

Gold ore was sourced from a mine in Kalgoorlie, WA Australia. The ore was crushed to approximately 30 microns and then 750 mg of the ore was treated in a plastic tube with a 20 mL solution of TCCA (0.1 M) and NaBr (0.3 M) and rotated at 20 RPM on an end-over-end mixer for 8 days at 25° C. After the leaching procedure, the sediment was allowed to settle to the bottom of the tube. The resulting gold concentration in the water was 30-40 ppm, as measured by ICP-MS (triplicate experiments). Next, 1 g of the canola oil polysulfide polymer bound in a cotton bag was added directly to the solutions and the gold uptake by the polymer was measured over 13 days. Over this time >97% of gold was removed from solution for all three samples. The presence of the gold on the polymer was confirmed by energy-dispersive X-ray spectroscopy (FIG. 8).

### Example 9—Gold Oxidation with Sonication

Gold metal (10 mg) was added to a 25 mL round bottom flask along with a 25 mL solution containing trichloroisocyanuric acid (290 mg) and sodium bromide (385 mg). The flask was lowered into an ultrasonication bath at a temperature of 60° C. The concentration of gold leached into solution was monitored by AAS throughout the reaction. >98% of the gold was leached into solution after 2 hours under these conditions and no solid gold was visible after this leaching procedure.

### Example 10—Selective Reduction and Precipitation of Gold in Solutions Containing Copper and Gold

Copper metal (2.00 g) and gold metal (1.00 g) were submerged in 400 mL of water and then trichloroisocyanuric acid (8.08 g) and potassium bromide (0.95 g) were added to the solution. The solution was stirred at room temperature to oxidise and dissolve all copper and gold. After all of the copper and gold were dissolved, ethylenediaminetetraacetic acid (EDTA, 18.41 g) was added to the solution. The solution changed in colour from green to blue as the EDTA bound to copper. Next, ascorbic acid (1.79 g) was added to the solution and the solution was immediately filtered to remove non-gold solids (such as precipitated trichloroisocyanuric acid or cyanuric acid). As the ascorbic acid reduced the gold in the filtered solution, gold metal deposited on the inside of the beaker and copper remained in solution as the blue copper-EDTA complex. The gold can be scraped off of the beaker and isolated by filtration. Additional ascorbic acid can be added to complete the gold reduction and recovery.

### Example 11—Extraction and Recovery of Gold from Electronic Waste

Trichloroisocyanuric acid (2.91 g) and sodium bromide (43 mg) were dissolved in 125 mL of water in a 250 mL plastic container. One RAM pin was cut up into several pieces and then added to the oxidant solution. The plastic container was then submerged in an ultrasonication water bath and heated at 50-60° C. with sonication. The gold was visibly removed from the RAM pin, typically after 2-5 hours. Analysis by atomic absorption spectroscopy (AAS) indicated that typically >95% of the gold was leached into solution, based on a comparison to an aqua regia digest, which quantitatively dissolves all gold. To recover the gold, it can be bound to a polymer sorbent or precipitated with ascorbic acid. For the former method, 500 mg of a polymer made from sulfur and castor oil by inverse vulcanisation was bound in a porous mesh and added to the solution and incubated for at least one day. The polymer was then removed from the solution, washed with water and then incinerated to recover the gold. To reduce and precipitate the gold using ascorbic acid, the solution was filtered and then EDTA was added to stabilise the copper in solution and then ascorbic acid was added at room temperature. EDTA was added in an amount such that there was 1-3 molar equivalents, relative to dissolved copper, as determined by AAS. The amount of ascorbic acid should be at least equimolar to the combined gold and active chlorine. Gold metal typically precipitates as gold metal or black particles and can be isolated by filtration. The recovered gold is typically isolated in >90% yield by either method.

### Example 12—Incineration of Polymeric Precious Metal Sorbent and Scrubbing of Off-Gases

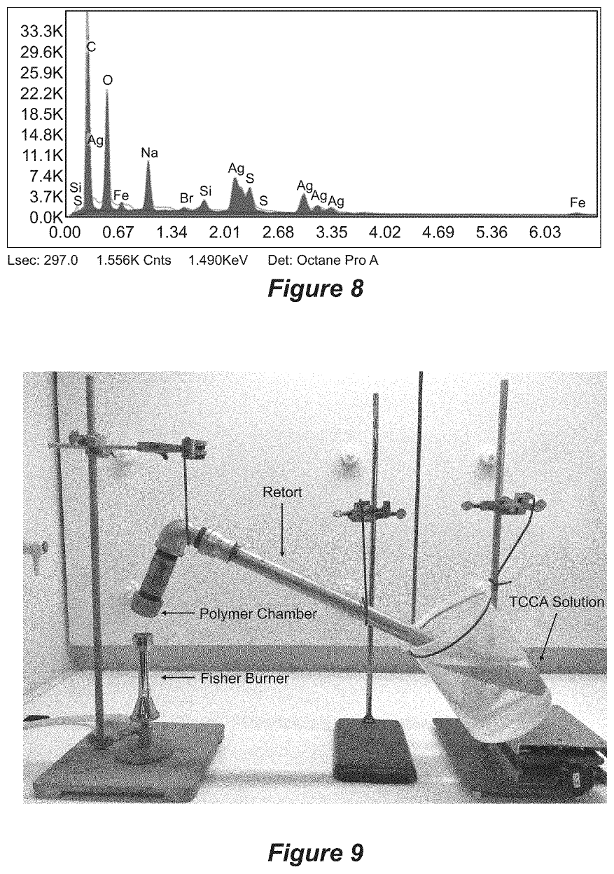

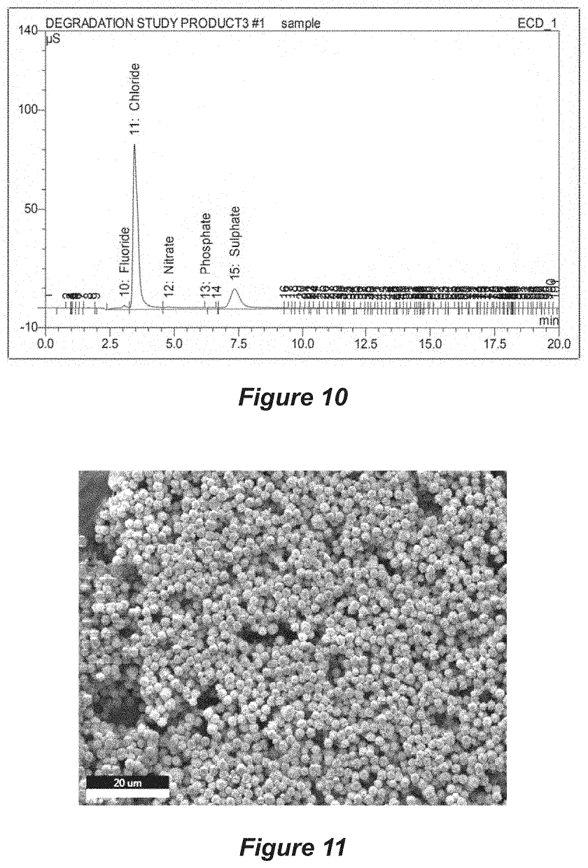

5 g of polymer sorbent of Example 1 was placed in a simple retort (FIG. 9). When the polymer is heated and decomposes by pyrolysis, the off gases exit the retort. The end of the retort was submerged in a solution of saturated trichloroisocyanuric acid in water (˜500 mL). The trichloroisocyanuric acid (TCCA) reagent is the same reagent used in the leach solution. As the off gases pass through the scrubbing solution, sulfur dioxide was converted to sulfate, as detecting by ion chromatography (FIG. 10). This is a convenient and simple scrubbing method that uses the same oxidants employed in the precious metal leaching.

### Example 13—Extraction and Recovery of Gold from Tailings

The tailings used in this example were sourced from a historic stamp mill that used mercury to amalgamate gold. The tailings, referred to here as battery sands, contain a complex mixture of elements (determined by a combination of spectroscopic methods including X-ray fluorescence and ICP-OES after chemical digestion, as shown in the following tables.

| | | | | | | C | | | |
|---|---|---|---|---|---|---|---|---|---|
| Ag | Al | Au | Ba | Be | Bi | org | Ca | Cd | Co |
| (ppm) | (ppm) | (ppm) | (%) | (ppm) | (ppm) | (%) | (%) | (ppm) | (ppm) |
| <2 | 6 | 1.60 | 0.02 | <5 | <10 | 0.30 | 2.66 | 5 | 35 |

| Cr | Cu | Fe | Hg | K | Li | Mg | Mn | Mo | Na |
|---|---|---|---|---|---|---|---|---|---|
| (ppm) | (ppm) | (%) | (ppm) | (%) | (ppm) | (%) | (%) | (ppm) | (%) |
| 330 | 156 | 8.80 | 4.2 | 0.59 | 30 | 1.73 | 0.09 | <5 | 0.83 |

| Ni | P | Pb | S | Si | Sr | Ti | V | Y | Zn |
|---|---|---|---|---|---|---|---|---|---|
| (ppm) | (ppm) | (ppm) | (%) | (%) | (ppm) | (%) | (ppm) | (ppm) | (ppm) |
| 60 | 700 | 180 | 1.44 | 26.8 | 108 | 0.69 | 232 | 15 | 404 |
| 115 | 500 | 165 | 0.23 | 28.2 | 74 | 0.49 | 284 | 15 | 386 |

A sample of the battery sand (5.0 g) was added to a plastic container along with sodium bromide (3.0 g), trichloroisocyanuric acid (2.32 g), and water (100 mL). The mixture was stirred for 72 hours at room temperature and then the composition of the leach solution was analysed by ICP-OES. The major components of the leach solution were gold, copper, iron, mercury, and nickel. The percent of the elements leached from the tailings was gold (>99%), copper (13%), iron (19%), mercury (>99%), and nickel (>99%). Next, a polymer sorbent made from copolymerised sulfur (50%) and castor oil (50%) was used to recover the gold. Accordingly, 1.0 g of the polysulfide polymer of Example 1 was added to the filtered solution and incubated for 72 hours. 88% of the gold was removed from the solution and bound to the polymer. The concentration of the other elements in the solution did not change. This indicates that the leach solution oxidises and leaches gold, mercury and nickel efficiently, with some oxidation of copper and iron. The polysulfide polymer was also shown to more rapidly remove gold than any other component of the leach solution. The amount of oxidant was not optimised, as this experiment was to demonstrate the potential for selectivity in gold leaching and recovery in complex tailings. Additionally, this experiment illustrates how the trichloroisocyanuric acid-based leach solution can also be used to wash mercury from tailings. The mercury can be removed from the leach solution by additional sulfur polymer or by the addition of activated carbon. This can also be used to leach mercury from soil, sludge and other mixed water and solid waste.

### Example 14—Reduction and Precipitation of Gold from Leach Solution Using Ascorbic Acid

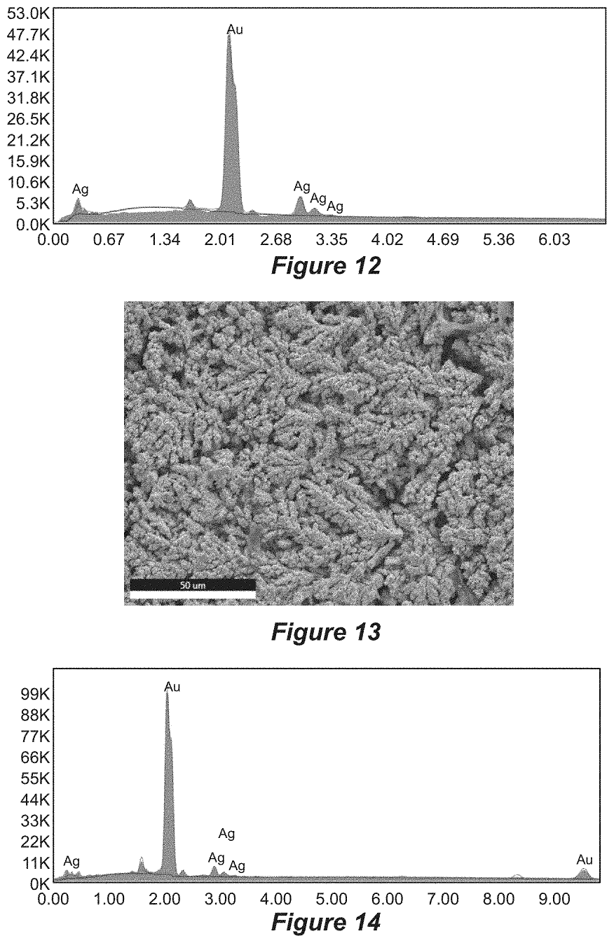

Gold metal (531 mg) was added to a solution of water (300 mL) containing trichloroisocyanuric acid (5.92 g) and sodium bromide (9.0 g). The mixture was stirred at room temperature until all gold was oxidised and dissolved. A 50 mL aliquot of the gold solution (1770 ppm gold) was then treated with 50 mL of an aqueous solution of ascorbic acid (0.2 M). Upon addition of the ascorbic acid, a black precipitate is generated within a few minutes. The colour of the leach solution also changes from orange to light yellow as the excess oxidant is converted to halide salts and cyanuric acid. The black solid was isolated by filtration and analysed by scanning electron microscopy (FIG. 11) and X-ray spectroscopy (EDX) (FIG. 12). The black solid was identified as gold particles.

### Example 15—Reduction and Precipitation of Gold from Leach Solution Using Hydrogen Gas

Gold metal (531 mg) was added to a solution of water (300 mL) containing trichloroisocyanuric acid (5.92 g) and sodium bromide (9.0 g). The mixture was stirred at room temperature until all gold was oxidised and dissolved. A 50 mL aliquot of the gold solution (1770 ppm gold) was then sparged with hydrogen gas for 2 hours, over which time a black precipitate was formed. The black solid was isolated by filtration and analysed by scanning electron microscopy (FIG. 13) and X-ray spectroscopy (EDX) (FIG. 14). The black solid was identified as gold.

### Example 16—Gold Recovery from Ore Concentrates

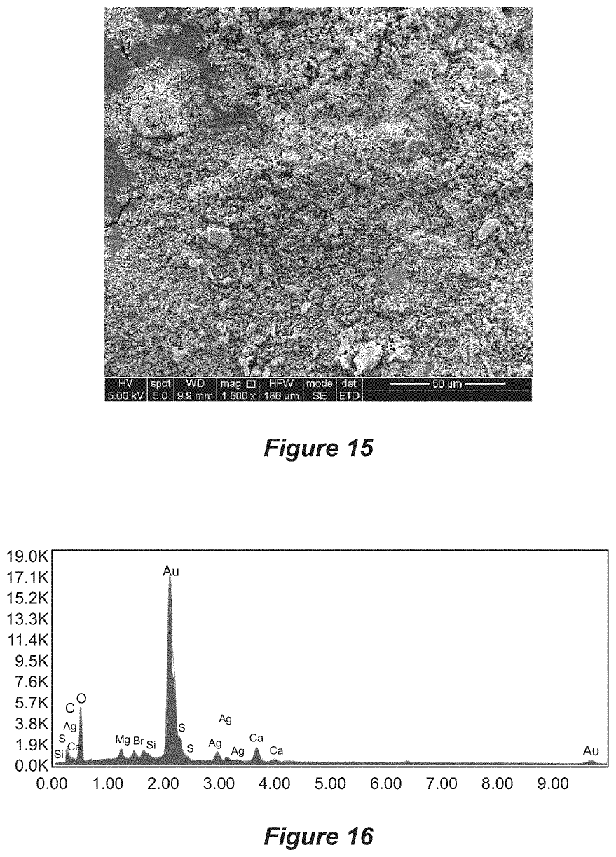

Ore was crushed in a ball mill and the fine gold was concentrated via a sluice and a shaker table. The resulting concentrates contained 75 g gold/tonne concentrate (75 ppm gold in the concentrates), as determined by fire assay. A sample of the concentrates (246 g) was added to a 5 L plastic bucket with 150 mL of water. Magnets were used to remove any magnetic material such as magnetite, which could react with the oxidant. Next, trichloroisocyanuric acid (4.85 g) and potassium bromide (0.285 g) was added and the solution was stirred using a plastic-coated impellar and overhead stirring device. After 24 hours, atomic absorption spectroscopy (AAS) analysis indicated that 90% of the gold had been leached into solution. Another dose of oxidant (1.76 g trichloroisocyanuric acid) was added to complete the oxidation and the leach solution was stirred for an additional 24 hours. After this time >99% of the gold was leached into the solution, as determined by AAS. The leach solution was then filtered to remove solids and the recovered liquid was treated with the canola oil polysulfide polymer (9.5 g). The concentration of gold was monitored by AAS over several days until at least 97% of the gold was removed from solution. This procedure is unoptimised and gold recovery can be increased in rate by the addition of more polymer. The polymer, after bound to gold, was recovered by filtration and incinerated to provide gold (FIGS. 15 and 16). Typically, the gold recovered from ore using this method appears as an orange powder after incineration of the polymer-gold complex.

### Example 17—Gold Recovery from Mixed Laboratory Waste

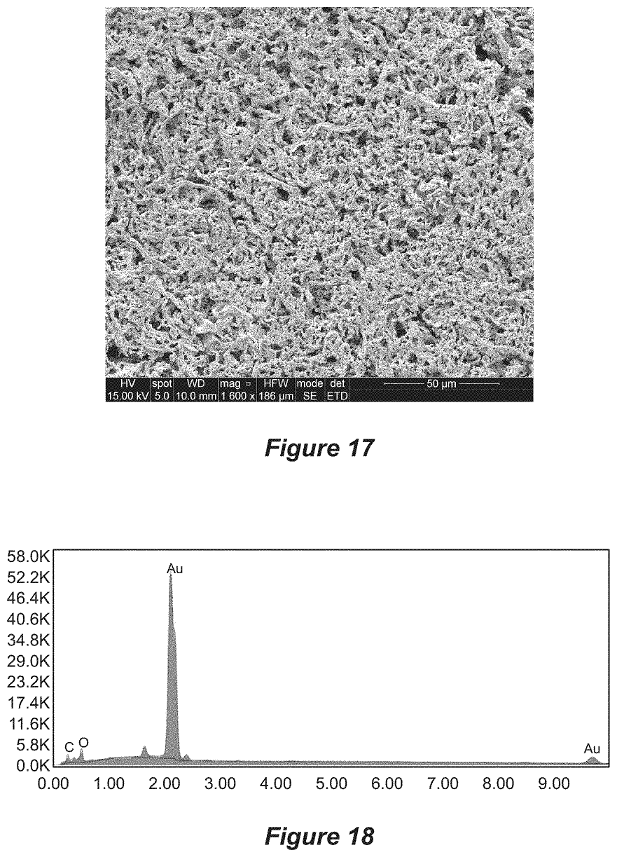

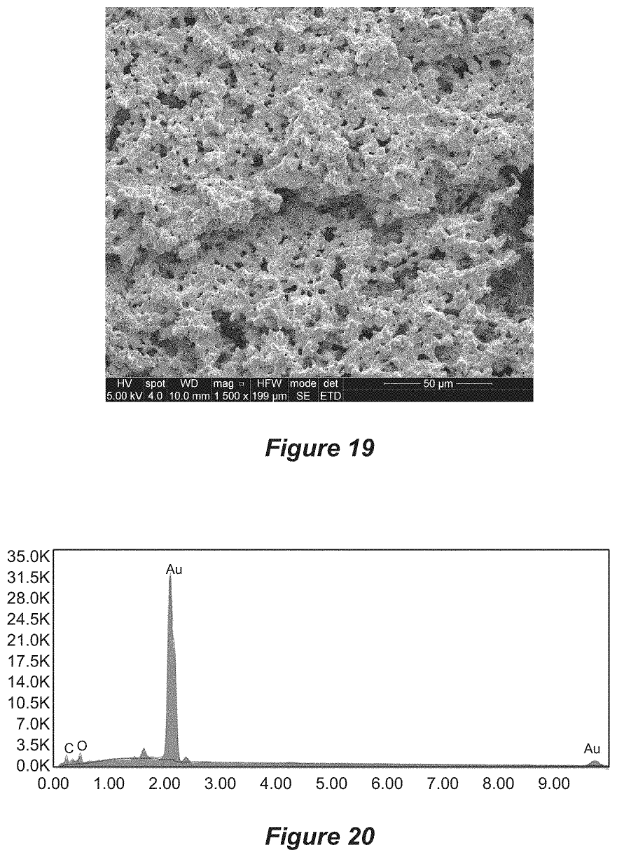

The walls of a laboratory sputter coater regularly used to coat samples with gold, silver and chromium was scrubbed with a mild detergent, a rough sponge and paper towels. The cleaning materials remove the metals from the walls of the coater as fine metal particles. Next, the sponges and paper towels were put into a 500 mL plastic container together with 600 mL of water, 13.92 g of trichloroisocyanuric acid (TCCA) and 1.14 g of potassium bromide. The solution was incubated without stirring for two days. No metal particles were visible after this time. The rate of metal oxidation and dissolution can be increased with heating and/or sonication. Next, the solution was filtered to remove the liquid containing oxidised and soluble gold. The gold could be recovered by binding to a polysulfide polymer or by reductive precipitation with ascorbic acid, as described next. Recovery of gold with polymer: A portion of the leach solution (265 mL) was mixed with a total of 10 g of polysulfide polymer of Example 1 with stirring for at least 24 hours or until the concentration of gold was reduced by >98%, as determined by AAS. The polymer was then recovered by filtration and incinerated using a torch or furnace to recover the gold in 97% isolated yield (FIGS. 17 and 18). Recovery of gold using ascorbic acid: A portion of the leach solution (265 mL) was mixed with 50 mg of ascorbic acid at room temperature with stirring. After 5 minutes gold precipitated as a black solid (>98% gold removed from the solution, as determined by AAS). The gold was isolated by filtration and recovered in 93% yield.

The reference to any prior art in this specification is not, and should not be taken as, an acknowledgement of any form of suggestion that such prior art forms part of the common general knowledge.

It will be appreciated by those skilled in the art that the disclosure is not restricted in its use to the particular application described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope of the disclosure as set forth and defined by the following claims.

### REFERENCES

1. Commercial Aspects of Gold Applications: From Materials Science to Chemical Science. C. W. Corti and R. J. Holliday. Gold Bull. 2004, 37, 20.
2. Recovery of gold from secondary sources—A review. S. Syed. Hydrometallurgy 2012, 115-116, 30-51.
3. A Review of Environmental Considerations on Gold Mining and Production. A. Muezzinoglu. Critical Reviews in Environmental Science and Technology 2010, 33, 45-71.
4. The Mercury Problem in Artisanal and Small-Scale Gold Mining. L. J. Esdaile and J. M. Chalker. Chem. Eur. J. 2018, 24, 6905-6916.
5. Thiosulfate leaching of gold—A review. M. G. Aylmore and D. M. Muir. Minerals Engineering 2001, 14, 135-174.
6. Bromine leaching as an alternative method for gold dissolution. R. Sousa, A. Futuro, A. Fiuza, M. C. Vila, and M. L. Dinis. Minerals Engineering, 2018, 118, 16-23.
7. Environmentally Benign, Rapid, and Selective Extraction of Gold from Ores and Waste Electronic Materials. C. Yue, H. Sun, W.-J. Liu, B. Guan, X. Deng, X. Zhang, and P. Yang. Angew Chem. Int. Ed. 2017, 56, 9331-9335.

1. A process for recovering a precious metal from a precious metal containing article or composition, the process comprising:
treating the precious metal containing article or composition with an oxidant composition under conditions to oxidise the precious metal in the precious metal containing article or composition to obtain a precious metal salt composition;
contacting the precious metal salt composition with a sorbent under conditions to adsorb at least some of the precious metal salt to the sorbent to obtain a laden sorbent; and
recovering at least some of the precious metal from the laden sorbent.

2. The process according to claim 1, wherein the precious metal is gold.

3. The process according to claim 1, wherein the precious metal is silver.

4. The process according to claim 1, wherein the oxidant composition comprises at least one halide ion source and at least one electrophilic halogen source.

5. (canceled)

6. The process according to claim 1, wherein the halide ion source is selected from one or more of the group consisting of sodium chloride, potassium chloride, hydrogen chloride, sodium bromide, potassium bromide, hydrogen bromide, sodium iodide, potassium iodide, and hydrogen iodide.

7.-10. (canceled)

11. The process according to claim 1, wherein the electrophilic halogen source is selected from one or more of the groups consisting of hypobromous acid, hypochlorous acid, hyprobromite salts, hypochlorite salts, bromochlorodimethylhydantoin (BCDMH), sodium dichloroisocyanurate (SDIC), dichloroisocyanuric acid, trichloroisocyanuric acid, sodium dibromoisocyanurate, dibromoisocyanuric acid, and tribromoisocyanuric acid.

12. The process according to claim 4, wherein the halide ion source is sodium bromide and the electrophilic halogen source is trichloroisocyanuric acid.

13. The process according to claim 1, wherein the sorbent is a polymeric polysulfide formed by reacting a fatty acid composition comprising at least one unsaturated fatty acid or derivative thereof with sulfur, at a weight ratio between 9:1 and 1:9, under inverse vulcanisation conditions to produce a polymeric polysulfide wherein at least 50% of the fatty acids or derivatives thereof in the fatty acid composition are unsaturated.

14. The process according to claim 13, wherein the fatty acid composition is a glyceride composition.

15.-22. (canceled)

23. The process according to claim 1, wherein the precious metal containing article or composition further comprises mercury which is oxidised by the oxidant composition to form the precious metal salt composition further comprising mercury salts, and the sorbent selectively removes the precious metal salts from the precious metal salt composition to provide a laden sorbent and a mercury salt laden leach solution.

24.-26. (canceled)

27. A precious metal recovered from a precious metal containing article or composition using the process of claim 1.

28. A process for recovering a precious metal from a precious metal containing article or composition, the process comprising:
treating the precious metal containing article or composition with an oxidant composition comprising at least one halide ion source and at least one electrophilic halogen source under conditions to oxidise the precious metal in the precious metal containing article or composition to obtain a precious metal salt composition; and
recovering at least some of the precious metal from the precious metal salt composition.

29. The process according to claim 28, wherein the precious metal is gold.

30. The process according to claim 28, wherein the precious metal is silver.

31. (canceled)

32. The process according to claim 28, wherein the halide ion source is selected from one or more of the group consisting of sodium chloride, potassium chloride, and hydrogen chloride, sodium bromide, potassium bromide, hydrogen bromide, sodium iodide, potassium iodide, and hydrogen iodide.

33.-36. (canceled)

37. The process according to claim 28, wherein the electrophilic halogen source is selected from one or more of the groups consisting of hypobromous acid, hypochlorous acid, hyprobromite salts, hypochlorite salts, bromochlorodimethylhydantoin (BCDMH), sodium dichloroisocyanurate (SDIC), dichloroisocyanuric acid, trichloroisocyanuric acid, sodium dibromoisocyanurate, dibromoisocyanuric acid, and tribromoisocyanuric acid.

38. The process according to claim 28, wherein the halide ion source is sodium bromide and the electrophilic halogen source is trichloroisocyanuric acid.

39.-43. (canceled)

44. The process according to claim 28, wherein the sorbent is a polymeric polysulfide formed by reacting a fatty acid composition comprising at least one unsaturated fatty acid or derivative thereof with sulfur, at a weight ratio between 9:1 and 1:9, under inverse vulcanisation conditions to produce a polymeric polysulfide wherein at least 50% of the fatty acids or derivatives thereof in the fatty acid composition are unsaturated.

45. The process according to claim 44, wherein the fatty acid composition is a glyceride composition.

46. The process according to claim 28, wherein the precious metal containing article or composition further comprises mercury which is oxidised by the oxidant composition to form the precious metal salt composition further comprising mercury salts, the process further comprising selectively removing the precious metal salts from the precious metal salt composition using a sorbent to provide a laden sorbent and a mercury salt laden leach solution.

47.-48. (canceled)
